(19) United States
(12) Patent Application Publication
(10) Pub. No.: US 2025/0342079 A1
(43) Pub. Date: Nov. 6, 2025

(54) METHOD FOR DETECTING FAULT, ELECTRONIC DEVICE AND STORAGE MEDIUM

(71) Applicant: Beijing Baidu Netcom Science Technology Co., Ltd., Beijing (CN)

(72) Inventors: Dianhai Yu, Beijing (CN); Liang Shen, Beijing (CN); Jiabin Yang, Beijing (CN); Yanjun Ma, Beijing (CN); Haifeng Wang, Beijing (CN)

(21) Appl. No.: 19/272,459

(22) Filed: Jul. 17, 2025

(30) Foreign Application Priority Data
Dec. 16, 2024 (CN) 202411855982.2

(51) Int. Cl. G06F 11/07

(52) U.S. Cl. CPC G06F 11/079; G06F 11/0709

(57) ABSTRACT

A method for detecting a fault, an electronic device and a storage medium are provided, relating to the field of computer technology, and in particular to the fields of deep learning, large model training, fault detection and other technologies. The method includes: determining a plurality of computing devices, where the plurality of computing devices are used to perform model training based on a pipeline parallelism strategy; determining a parameter and a scheduling strategy used by the pipeline parallelism strategy; determining idle time of each computing device among the plurality of computing devices in a model training process based on the parameter and the scheduling strategy; and performing fault detection on each computing device during the idle time of each computing device in the model training process.

### CROSS-REFERENCE TO RELATED APPLICATIONS

The present application claims priority to Chinese Patent Application No. CN202411855982.2, filed with the China National Intellectual Property Administration on Dec. 16, 2024, the disclosure of which is hereby incorporated herein by reference in its entirety.

### TECHNICAL FIELD

The present disclosure relates to the field of computer technology, and in particular to the fields of deep learning, large model training, fault detection and other technologies.

### BACKGROUND

In recent years, with the continuous expansion of the scale of deep learning models, distributed cluster training has become a necessary technical means to train large deep learning models. In actual cluster training, computing devices often fail. The traditional fault detection method usually requires pausing the entire training task and performing offline fault detection. This method is not only time-consuming but also reduces the model training efficiency. Therefore, how to achieve real-time fault detection of computing devices without affecting training efficiency has become a problem to be solved urgently.

### SUMMARY

The present disclosure provides a method and an apparatus for detecting a fault, a device and a storage medium.

According to one aspect of the present disclosure, provided is a method for detecting a fault, including:
determining a plurality of computing devices, where the plurality of computing devices are used to perform model training based on a pipeline parallelism strategy;
determining a parameter and a scheduling strategy used by the pipeline parallelism strategy;
determining idle time of each computing device among the plurality of computing devices in a model training process based on the parameter and the scheduling strategy; and
performing fault detection on each computing device during the idle time of each computing device in the model training process.

According to another aspect of the present disclosure, provided is an apparatus for detecting a fault, including:
a first determining module configured to determine a plurality of computing devices, where the plurality of computing devices are used to perform model training based on a pipeline parallelism strategy;
a second determining module configured to determine a parameter and a scheduling strategy used by the pipeline parallelism strategy;
a third determining module configured to determine idle time of each computing device among the plurality of computing devices in a model training process based on the parameter and the scheduling strategy; and
a fault detection module configured to perform fault detection on each computing device during the idle time of each computing device in the model training process.

According to yet another aspect of the present disclosure, provided is an electronic device, including:
at least one processor; and
a memory connected in communication with the at least one processor;
where the memory stores an instruction executable by the at least one processor, and the instruction, when executed by the at least one processor, enables the at least one processor to execute the method of any embodiment of the present disclosure.

According to yet another aspect of the present disclosure, provided is a non-transitory computer-readable storage medium storing a computer instruction thereon, and the computer instruction is used to cause a computer to execute the method according to any one of the embodiments of the present disclosure.

According to yet another aspect of the present disclosure, provided is a computer program product including a computer program, and the computer program implements the method according to any one of the embodiments of the present disclosure, when executed by a processor.

The present disclosure determines the idle time of each computing device in the model training process based on the parameter of the pipeline parallelism scheduling strategy and the scheduling strategy, and performs fault detection on each computing device during the idle time. Since the fault detection is performed during the idle time, there is no need to interrupt the model training process, and online fault detection can be performed on each computing device, reducing the interruption time in the model training process and thereby improving the model training efficiency.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a schematic diagram of an application scenario according to an embodiment of the present disclosure.

FIG. 2 is a flowchart of an implementation of a method for detecting a fault according to an embodiment of the present disclosure.

FIG. 3 is a schematic diagram of a non-interleaved pipeline scheduling strategy.

FIG. 4 is a schematic diagram of an interleaved pipeline scheduling strategy.

FIG. 5 is a schematic diagram of the idle time of each computing device in the non-interleaved pipeline scheduling strategy.

FIG. 6 is a schematic diagram of the idle time of each computing device in the interleaved pipeline scheduling strategy.

FIG. 7 is a structural schematic diagram of an apparatus for detecting a fault 700 according to an embodiment of the present disclosure.

FIG. 8 shows a schematic block diagram of an exemplary electronic device 800 that may be used to implement the embodiments of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope of the present disclosure. Likewise, for clarity and conciseness, descriptions of well-known functions and structures are omitted in the following descriptions.

The term “and/or” in the embodiments of the present disclosure indicates that there may be three relationships, for example, A and/or B may represent: only A, both A and B, and only B. The term “at least one” herein indicates any one of many items, or any combination of at least two of the many items, for example, at least one of A, B or C may indicate any one or more elements selected from a set of A, B and C. The terms “first” and “second” herein indicate a plurality of similar technical terms and distinguish them from each other, but do not limit an order of them or limit that there are only two items, for example, a first feature and a second feature indicate two types of features/two features, a quantity of the first feature may be one or more, and a quantity of the second feature may also be one or more.

In recent years, with the rapid development of the deep learning technology, the scale of models is also constantly expanding. This trend prompts large-scale distributed training to become a necessary means to train large and complex deep learning models. The pipeline parallelism strategy is an efficient strategy in distributed training methods. This strategy distributes different layers of a model to different computing devices, and allows the model to perform forward and backward propagation simultaneously on multiple computing devices. Different computing devices may perform calculations at different stages of the model, realizing pipeline parallelism calculation. In pipeline parallelism calculation, data may be transmitted between adjacent computing devices through communication links. This parallel processing method can significantly reduce the calculation load of a single computing device, but at the same time, also requires a more refined and complex coordination mechanism to ensure the smooth progress of the training process.

However, in actual large-scale cluster training, the pipeline parallelism strategy has brought significant performance improvement, but device fault problems still occur frequently. These faults may stem from a variety of reasons, including: uncertainty in model calculation accuracy, errors caused by hardware aging, and unstable network connection, etc. The occurrence of these faults will not only have a negative impact on the accuracy of the training result and reduce the performance of the model, but also may lead to the interruption of the entire training task, thereby resulting in the waste of time and computing resources.

In the current existing method for fault detection, it is usually necessary to pause the entire training task and perform offline fault detection and repair on each device. This method cannot take a long time and will also waste computing resources due to long downtime. Therefore, how to achieve the online fault detection of devices and discover and deal with potential problems timely without affecting the training efficiency to ensure the continuity and stability of model training is a problem to be solved urgently in the field of deep learning.

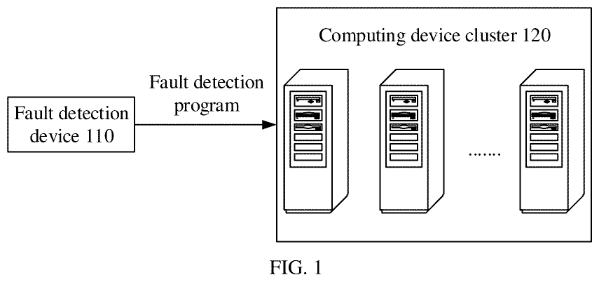

In order to solve the above problem, an embodiment of the present disclosure proposes a method for detecting a fault. FIG. 1 is a schematic diagram of an application scenario according to an embodiment of the present disclosure. As shown in FIG. 1, the schematic diagram of the application scenario in the embodiment of the present disclosure may include but is not limited to a fault detection device 110 and a computing device cluster 120. The fault detection device 110 and the computing device cluster 120 may communicate with each other through any type of wired or wireless network. Specifically, the computing device cluster 120 calls a fault detection program from the fault detection device 110 to perform fault detection on the computing devices in the idle state in the computing device cluster 120. The embodiment of the present disclosure does not impose any specific limitation on the number of fault detection devices 110. For example, one or more fault detection devices 110 may be included in the schematic diagram of the application scenario in the embodiment of the present disclosure. In the embodiment of the present disclosure, the computing device may be a high-performance computer, a Graphics Processing Unit (GPU), a Tensor Processing Unit (TPU), or any other device capable of supporting the training of deep learning models.

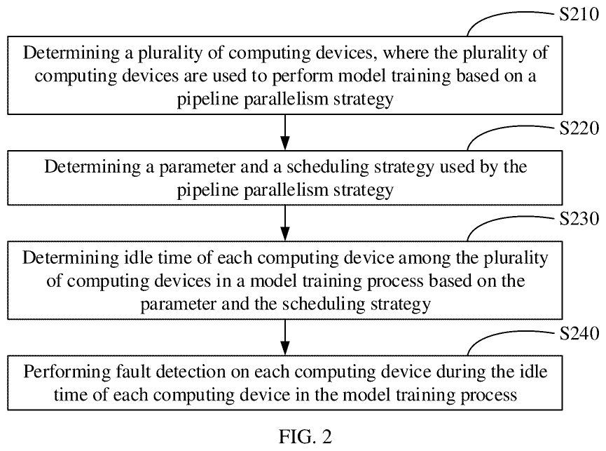

FIG. 2 is a flowchart of an implementation of a method for detecting a fault according to an embodiment of the present disclosure, including:

S210: determining a plurality of computing devices, where the plurality of computing devices are used to perform model training based on a pipeline parallelism strategy;

S220: determining a parameter and a scheduling strategy used by the pipeline parallelism strategy;

S230: determining idle time of each computing device among the plurality of computing devices in a model training process based on the parameter and the scheduling strategy; and

S240: performing fault detection on each computing device during the idle time of each computing device in the model training process.

By determining the idle time of each computing device and performing fault detection on each computing device during the idle time when using the pipeline scheduling strategy for model training, the interruption of model training due to fault detection can be avoided, thereby improving the model training efficiency.

In some implementations, the parameter includes a pipeline dimension.

In the embodiment of the present disclosure, the parameter of the pipeline scheduling strategy includes the pipeline dimension, also known as pipeline depth, which refers to the number of computing devices participating in model training in the pipeline scheduling strategy. The idle time of each computing device may be determined according to the pipeline dimension in combination with the scheduling strategy specifically used.

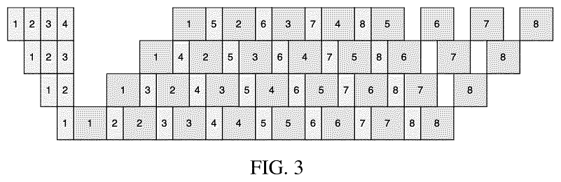

In the embodiment of the present disclosure, the pipeline scheduling strategy includes non-interleaved pipeline scheduling and interleaved pipeline scheduling. A schematic diagram of a non-interleaved pipeline scheduling strategy is shown in FIG. 3. The horizontal direction represents the number of calculation steps of one computing device. In this pipeline scheduling strategy, one computing device can perform one forward calculation and one backward calculation of the model. In this figure, the rectangle corresponds to the number of steps in the forward calculation, and the square corresponds to the number of steps in the backward calculation. Assume that 8 micro-batches need to be calculated, which may be divided into two blocks. Four computing devices are first used to sequentially calculate the micro-batches (numbered 1 to 4) in the first block, and then sequentially calculate the micro-batches (numbered 5 to 8) in the second block.

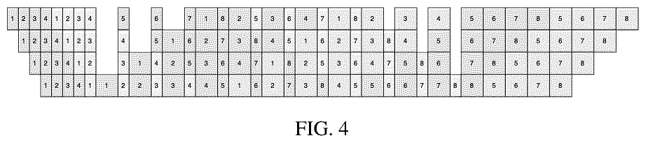

In an embodiment of the present disclosure, a schematic diagram of an interleaved pipeline scheduling strategy is shown in FIG. 4. The interleaving times of the interleaving pipeline scheduling strategy is 2, and one computing device may perform multiple forward calculations and multiple backward calculations on the model. After the first to fourth computing devices perform forward calculations on one micro-batch in sequence, the fourth computing device needs to feed back the calculation result to the first computing device for forward calculation again. For example, after the first computing device performs the first forward calculation on micro-batch 1 in the first step, the first computing device performs the second forward calculation on micro-batch 1 in the fifth step. In this scheduling strategy, the backward calculation process is also similar. The first computing device needs to feed back the backward calculation result to the fourth computing device for backward calculation again.

In some implementations, the step of determining idle time of each computing device among the plurality of computing devices in a model training process based on the parameter and the scheduling strategy includes:
determining the number of idle times of each computing device in the model training process according to the pipeline dimension; and
determining the idle time of each computing device in the model training process based on the number and a distribution rule of the idle times specified by the scheduling strategy.

In some implementations, the model is divided into a plurality of micro-batches; and
the distribution rule includes:
for each micro-batch, in a forward calculation process of the micro-batch, the plurality of computing devices sequentially perform calculation processes for the micro-batch in a first order; and each computing device waits for other computing devices before the computing device to complete calculation before performing calculation, where the waiting time is the idle time; and
in a backward calculation process of the micro-batch, the plurality of computing devices sequentially execute calculation processes for the micro-batch in a reverse order of the first order; and each computing device waits for other computing devices behind the computing device to complete calculation before performing calculation, and the waiting time is the idle time.

In the two pipeline scheduling strategies described above, the number of idle times of each computing device is fixed. Assuming that the pipeline dimension is P, the number of idle times of each computing device is 2×(P−1). For example, the pipeline dimension of the pipeline scheduling strategy is 4 in FIG. 3 or FIG. 4, and thus the number of idle times of each computing device is 6.

Based on the determined number of idle times of the computing device in combination with the distribution rule of the idle times clearly specified in the pipeline scheduling strategy, the idle time of the computing device in the entire model training cycle can be determined by analyzing a relationship between the rule and the number of idle times generated by each computing device in the model training process.

Here, the idle time of each computing device in the pipeline scheduling strategy is mainly distributed in two stages of forward calculation and backward calculation.

(1) During the forward calculation for a micro-batch, the computing devices calculate the micro-batch sequentially in the first order. In the first order, if the previous computing device has not completed the calculation for the micro-batch, then the subsequent computing device needs to wait for the previous computing device to transmit data thereto, where the waiting time is the idle time.

(2) During the backward calculation for a micro-batch, the computing devices calculate the micro-batch sequentially in the reverse order of the first order. In this order, if the subsequent computing device has not completed the calculation for the micro-batch, then the previous computing device needs to wait for the subsequent computing device to transmit data thereto, where the waiting time is the idle time.

The use of the distribution rule of the idle time of each computing device in the pipeline scheduling strategy helps to determine the time during which each computing device is in the idle state, and then use the idle time to realize the online fault detection of the computing device.

In some implementations, the step of performing fault detection on each computing device includes:

for each computing device, calling a fault detection program during the idle time of the computing device to implement fault detection of the computing device.

The fault detection program is called during the idle time of the computing device, aiming to utilize the idle time to perform fault detection on the computing device. This approach ensures the continuity and stability of computing devices during model training, and can perform online fault detection on computing devices without affecting the model training process.

In some implementations, the method further includes: determining the fault detection program, where the fault detection program is used to detect at least one of hardware status, calculation accuracy, or memory and storage medium of the computing device.

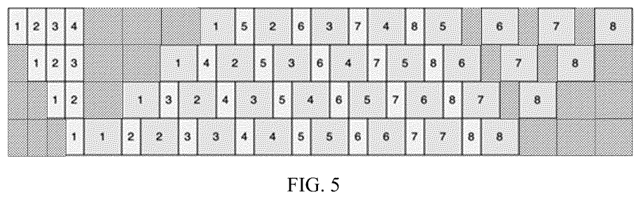

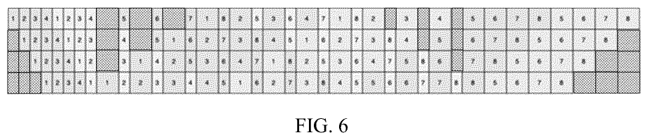

FIG. 5 is a schematic diagram of the idle time of each computing device in the non-interleaved pipeline scheduling strategy. FIG. 6 is a schematic diagram of the idle time of each computing device in the interleaved pipeline scheduling strategy. The graphic marking area in FIG. 5 and FIG. 6 is the idle time of each computing device. During each idle time, the fault detection program may be called to perform fault detection on the corresponding computing device. The corresponding measures are taken according to the fault detection result.

In some examples, the fault detection program is used to comprehensively check multiple core components and performance indicators of the computing device. The hardware status detection function mainly focuses on the physical hardware components such as Central Processing Unit (CPU), GPU, motherboard, power supply, etc. of the computing device. The fault detection program may run a series of diagnostic tests to check whether the hardware is in the normal working state. For example, the temperature, voltage, current and other parameters of the hardware are checked to ensure that these parameters do not exceed the safe ranges.

In some implementations, detecting the calculation accuracy includes:
controlling the computing device to execute a preset calculation task and obtain a calculation result;
comparing the calculation result with an expected result of the calculation task; and
determining a detection result of the calculation accuracy according to a comparison result.

The calculation accuracy is one of indicators for evaluating the performance of the computing device. The fault detection program performs a series of preset mathematical operations or scientific calculation tasks, and then compares the difference between the actual calculation result and the expected result. If the difference exceeds an acceptable range, indicating that the computing device has a problem with the model training accuracy, further maintenance is required. In this way, the calculation accuracy of the computing device can be evaluated, and then the computing device with the problem of calculation accuracy can be found according to the evaluation result.

In some implementations, detecting the memory and storage medium includes:

detecting at least one of memory leak and read/write anomaly.

The memory and storage medium (such as hard disk, solid state disk, etc.) are key components for storing data and programs in the computing device. The fault detection program may perform memory tests, including memory leak and read/write anomaly. It is detected whether there is a memory leak, that is, whether there are memory blocks that are not released correctly or cannot be effectively recovered in the program running process. These unreleased memories may cause system resources to be gradually exhausted, thereby affecting the stability and performance of the system. At the same time, the fault detection program also detects whether there is an anomaly in the read/write process of the memory and storage medium, such as a significant decrease in read/write speed, frequent read/write errors, or damaged data integrity or other read/write anomaly problems. These problems may directly affect the accuracy and security of the data.

By detecting the memory and storage medium, it is possible to discover possible faults and potential problems in the memory management and storage medium of the computing device.

By using the fault detection program to detect the hardware status, calculation accuracy, memory and storage medium of the computing device, it is possible to discover potential anomalies and faults of the computing device and then process the computing device for the anomalies and faults.

In some implementations, the method further includes:
stopping the model training process when detecting a fault in any one of the computing devices.

When the fault detection program detects a fault in a computing device, the fault detection program first triggers the fault recording mechanism, which ensures that the key information about the fault can be recorded accurately and completely. The recorded information includes but is not limited to: device identifier, fault type (such as hardware fault, abnormal calculation accuracy, memory error or storage medium damage, etc.), detection time, etc.

After the fault information is recorded, the fault information is notified by the monitoring system to the relevant operation and maintenance personnel or the automated processing module. This step enables the fault to be known and corresponding measures to be taken. The notification mechanism may include email, short message, instant message notification, or pushing by a dedicated operation and maintenance relationship platform. For the automated processing module, the notification may directly trigger a preset fault handling process, such as automatically restarting the device, interrupting the training task, etc.

When detecting a fault in any computing device, the system may trigger an emergency response process to stop the ongoing model training process. Specifically, the system may firstly confirm the authenticity and accuracy of the fault information. Once it is confirmed that the computing device indeed has a fault, the system may trigger a global pause instruction whether the fault is a hardware-level fault or a software-level anomaly. This instruction may be conveyed to all computing devices involved in model training, to require each computing device to stop the current task. When no computing device with a fault is detected, the model training task is kept running continuously.

Taking the above measures can avoid the adverse effect on the model training result caused by the fault of the computing device in the training process. At the same time, the fault of the computing device can be investigated and repaired after the model training process is stopped.

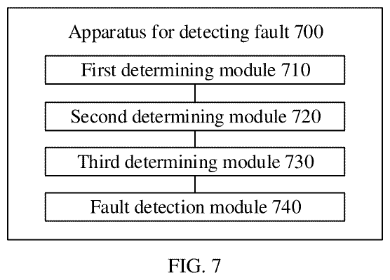

An embodiment of the present disclosure further provides an apparatus for detecting a fault. FIG. 7 is a structural schematic diagram of an apparatus for detecting a fault 700 according to an embodiment of the present disclosure, including:
a first determining module 710 configured to determine a plurality of computing devices, where the plurality of computing devices are used to perform model training based on a pipeline parallelism strategy;
a second determining module 720 configured to determine a parameter and a scheduling strategy used by the pipeline parallelism strategy;
a third determining module 730 configured to determine idle time of each computing device among the plurality of computing devices in a model training process based on the parameter and the scheduling strategy; and a fault detection module 740 configured to perform fault detection on each computing device during the idle time of each computing device in the model training process.

In some implementations, the parameter includes a pipeline dimension.

In some implementations, the third determining module 730 is configured to:
determine the number of idle times of each computing device in the model training process according to the pipeline dimension; and
determine the idle time of each computing device in the model training process based on the number and a distribution rule of the idle times specified by the scheduling strategy.

In some implementations, the model is divided into a plurality of micro-batches; and the distribution rule includes:
for each micro-batch, in a forward calculation process of the micro-batch, the plurality of computing devices sequentially perform calculation processes for the micro-batch in a first order; and each computing device waits for other computing devices before the computing device to complete calculation before performing calculation, where the waiting time is the idle time; and
in a backward calculation process of the micro-batch, the plurality of computing devices sequentially execute calculation processes for the micro-batch in a reverse order of the first order; and each computing device waits for other computing devices behind the computing device to complete calculation before performing calculation, and the waiting time is the idle time.

In some implementations, the fault detection module 740 is configured to:
for each computing device, call a fault detection program during the idle time of the computing device to implement fault detection of the computing device.

In some implementations, the fault detection module 740 is further configured to: determine the fault detection program, where the fault detection program is used to detect at least one of hardware status, calculation accuracy, or memory and storage medium of the computing device.

In some implementations, the fault detection module 740 is configured to:
control the computing device to execute a preset calculation task and obtain a calculation result;
compare the calculation result with an expected result of the calculation task; and
determine a detection result of the calculation accuracy according to a comparison result.

In some implementations, the fault detection module 740 is configured to:
detect at least one of memory leak and read/write anomaly.

In some implementations, the fault detection module 740 is further configured to: stop the model training process when detecting a fault in any one of the computing devices.

For the description of specific functions and examples of the modules and sub-modules of the apparatus of the embodiment of the present disclosure, reference may be made to the relevant description of the corresponding steps in the above-mentioned method embodiments, and details are not repeated here.

In the technical solution of the present disclosure, the acquisition, storage and application of the user's personal information involved are in compliance with relevant laws and regulations, and do not violate public order and good customs.

According to the embodiments of the present disclosure, the present disclosure also provides an electronic device, a readable storage medium and a computer program product.

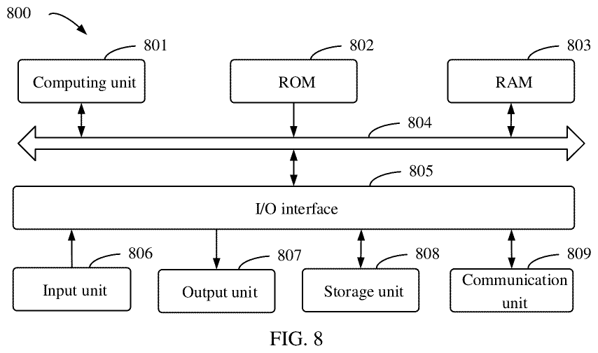

FIG. 8 shows a schematic block diagram of an exemplary electronic device 800 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 8, the device 800 includes a computing unit 801 that may perform various appropriate actions and processes according to a computer program stored in a Read-Only Memory (ROM) 802 or a computer program loaded from a storage unit 808 into a Random Access Memory (RAM) 803. Various programs and data required for an operation of device 800 may also be stored in the RAM 803. The computing unit 801, the ROM 802 and the RAM 803 are connected to each other through a bus 804. The input/output (I/O) interface 805 is also connected to the bus 804.

A plurality of components in the device 800 are connected to the I/O interface 805, and include an input unit 806 such as a keyboard, a mouse, or the like; an output unit 807 such as various types of displays, speakers, or the like; the storage unit 808 such as a magnetic disk, an optical disk, or the like; and a communication unit 809 such as a network card, a modem, a wireless communication transceiver, or the like. The communication unit 809 allows the device 800 to exchange data with other devices through a computer network such as the Internet and/or various telecommunication networks.

The computing unit 801 may be various general-purpose and/or special-purpose processing components with processing and computing capabilities. Some examples of the computing unit 801 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 801 performs various methods and processes described above, such as the detection method. For example, in some implementations, the detection method may be implemented as a computer software program tangibly contained in a computer-readable medium, such as the storage unit 808. In some implementations, a part or all of the computer program may be loaded and/or installed on the device 800 via the ROM 802 and/or the communication unit 809. When the computer program is loaded into the RAM 803 and executed by the computing unit 801, one or more steps of the detection method described above may be performed. Alternatively, in other implementations, the computing unit 801 may be configured to perform the detection method by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method for detecting a fault, comprising:
determining a plurality of computing devices, wherein the plurality of computing devices are used to perform model training based on a pipeline parallelism strategy;
determining a parameter and a scheduling strategy used by the pipeline parallelism strategy;
determining idle time of each computing device among the plurality of computing devices in a model training process based on the parameter and the scheduling strategy; and
performing fault detection on each computing device during the idle time of each computing device in the model training process.

2. The method of claim 1, wherein the parameter comprises a pipeline dimension.

3. The method of claim 2, wherein determining the idle time of each computing device among the plurality of computing devices in the model training process based on the parameter and the scheduling strategy, comprises:
determining the number of idle times of each computing device in the model training process according to the pipeline dimension; and
determining the idle time of each computing device in the model training process based on the number and a distribution rule of the idle times specified by the scheduling strategy.

4. The method of claim 3, wherein the model is divided into a plurality of micro-batches; and
the distribution rule comprises:
for each micro-batch, in a forward calculation process of the micro-batch, the plurality of computing devices sequentially perform calculation processes for the micro-batch in a first order; and each computing device waits for other computing devices before the computing device to complete calculation before performing calculation, wherein the waiting time is the idle time; and
in a backward calculation process of the micro-batch, the plurality of computing devices sequentially execute calculation processes for the micro-batch in a reverse order of the first order; and each computing device waits for other computing devices behind the computing device to complete calculation before performing calculation, and the waiting time is the idle time.

5. The method of claim 1, wherein performing the fault detection on each computing device, comprises:
for each computing device, calling a fault detection program during the idle time of the computing device to implement fault detection of the computing device.

6. The method of claim 5, further comprising: determining the fault detection program, wherein the fault detection program is used to detect at least one of hardware status, calculation accuracy, or memory and storage medium of the computing device.

7. The method of claim 6, wherein detecting the calculation accuracy comprises:
controlling the computing device to execute a preset calculation task and obtain a calculation result;
comparing the calculation result with an expected result of the calculation task; and
determining a detection result of the calculation accuracy according to a comparison result.

8. The method of claim 7, wherein detecting the memory and storage medium comprises:
detecting at least one of memory leak and read/write anomaly.

9. The method of claim 1, further comprising:
stopping the model training process, in a case of a fault in any one of the computing devices is detected.

10. An electronic device, comprising:
at least one processor; and
a memory connected in communication with the at least one processor;
wherein the memory stores an instruction executable by the at least one processor, and the instruction, when executed by the at least one processor, enables the at least one processor to execute:
determining a plurality of computing devices, wherein the plurality of computing devices are used to perform model training based on a pipeline parallelism strategy;
determining a parameter and a scheduling strategy used by the pipeline parallelism strategy;
determining idle time of each computing device among the plurality of computing devices in a model training process based on the parameter and the scheduling strategy; and
performing fault detection on each computing device during the idle time of each computing device in the model training process.

11. The electronic device of claim 10, wherein the parameter comprises a pipeline dimension.

12. The electronic device of claim 11, wherein the instruction, when executed by the at least one processor, enables the at least one processor to execute determining the idle time of each computing device among the plurality of computing devices in the model training process based on the parameter and the scheduling strategy, by:
determining the number of idle times of each computing device in the model training process according to the pipeline dimension; and
determining the idle time of each computing device in the model training process based on the number and a distribution rule of the idle times specified by the scheduling strategy.

13. The electronic device of claim 12, wherein the model is divided into a plurality of micro-batches; and
the distribution rule comprises:
for each micro-batch, in a forward calculation process of the micro-batch, the plurality of computing devices sequentially perform calculation processes for the micro-batch in a first order; and each computing device waits for other computing devices before the computing device to complete calculation before performing calculation, wherein the waiting time is the idle time; and
in a backward calculation process of the micro-batch, the plurality of computing devices sequentially execute calculation processes for the micro-batch in a reverse order of the first order; and each computing device waits for other computing devices behind the computing device to complete calculation before performing calculation, and the waiting time is the idle time.

14. The electronic device of claim 10, wherein the instruction, when executed by the at least one processor, enables the at least one processor to execute performing the fault detection on each computing device, by:
for each computing device, calling a fault detection program during the idle time of the computing device to implement fault detection of the computing device.

15. The electronic device of claim 14, wherein the instruction, when executed by the at least one processor, enables the at least one processor to further execute:
determining the fault detection program, wherein the fault detection program is used to detect at least one of hardware status, calculation accuracy, or memory and storage medium of the computing device.

16. A non-transitory computer-readable storage medium storing a computer instruction thereon, wherein the computer instruction is used to cause a computer to execute:
determining a plurality of computing devices, wherein the plurality of computing devices are used to perform model training based on a pipeline parallelism strategy;
determining a parameter and a scheduling strategy used by the pipeline parallelism strategy;
determining idle time of each computing device among the plurality of computing devices in a model training process based on the parameter and the scheduling strategy; and
performing fault detection on each computing device during the idle time of each computing device in the model training process.

17. The non-transitory computer-readable storage medium of claim 16, wherein the parameter comprises a pipeline dimension.

18. The non-transitory computer-readable storage medium of claim 17, wherein the computer instruction is used to cause the computer to execute determining the idle time of each computing device among the plurality of computing devices in the model training process based on the parameter and the scheduling strategy, by:
determining the number of idle times of each computing device in the model training process according to the pipeline dimension; and
determining the idle time of each computing device in the model training process based on the number and a distribution rule of the idle times specified by the scheduling strategy.

19. The non-transitory computer-readable storage medium of claim 18, wherein the model is divided into a plurality of micro-batches; and
the distribution rule comprises:
for each micro-batch, in a forward calculation process of the micro-batch, the plurality of computing devices sequentially perform calculation processes for the micro-batch in a first order; and each computing device waits for other computing devices before the computing device to complete calculation before performing calculation, wherein the waiting time is the idle time; and
in a backward calculation process of the micro-batch, the plurality of computing devices sequentially execute calculation processes for the micro-batch in a reverse order of the first order; and each computing device waits for other computing devices behind the computing device to complete calculation before performing calculation, and the waiting time is the idle time.

20. The non-transitory computer-readable storage medium of claim 16, wherein the computer instruction is used to cause the computer to execute performing the fault detection on each computing device, by:
for each computing device, calling a fault detection program during the idle time of the computing device to implement fault detection of the computing device.
